(19) United States
(12) Patent Application Publication
(10) Pub. No.: US 2011/0208771 A1
(43) Pub. Date: Aug. 25, 2011

(54) Collaborative online search tool

(76) Inventors: Anthony Constantine Milou, Sydney (AU); Aaron Travis Beckman, Olathe, KS (US)

(21) Appl. No.: 12/932,023

(22) Filed: Feb. 16, 2011

Related U.S. Application Data
(60) Provisional application No. 61/338,533, filed on Feb. 19, 2010.

(51) Int. Cl. G06F 17/30

(52) U.S. Cl. 707/769; 707/E17.014

(57) ABSTRACT

The invention is a computerized process for the collaborative finding and understanding of information on the World Wide Web through the end user input of queries in the form of text and images, which in turn filter interchangeable localized and third party databases resulting in the output of a specific set of search results. This computerized process is embodied by online software that enables end users to first input text or images and secondly manually drag and drop that input into an arrangement within a spatial environment. Communication features then make it possible for communication to occur between users in order to facilitate the understanding of a given input. The arrangement of text and images, as well as the selection of local and third party databases, may be saved so that one or multiple users may return for further input and communication at a later date and time.

### RELATED APPLICATIONS

This application claims the benefit of U.S. Provisional Patent Application Ser. No. 61/338,533 titled Collaborative Online Search Tool, filed on Feb. 19, 2010 by the inventors of the present application, the contents of which are incorporated herein by reference.

### BACKGROUND OF THE INVENTION

1. Field of the Invention

The present invention relates generally to a collaborative online search tool.

2. Background

Communications networks such as the Internet have grown in importance over time and have become an ever increasing source of information and news. As the Internet has become used by more and more people as a source of obtaining information and doing research, search technologies have continued to evolve in an effort to provide individual users with the ability to retrieve relevant information that can be digested, understood and synthesized into knowledge.

As the Internet has flourished, the number of websites and web pages continues to grow. By some estimates there are well over 200,000,000 websites on the Internet presently, and close to 2 billion Internet users. With this extraordinary number of websites available, and recent decisions by popular search engines such as Google to index micro-blog entries, such as Twitter tweets, the growth of the Internet has made the ability to find relevant information ever more difficult.

A lot of time and effort is expended by individuals simply finding their way to online information that others may have already come across and identified as useful. Subsequent users would undoubtedly like to know when previous users have spent considerable amounts of time investigating a topic and gain the benefit of the previously discovered information. Unfortunately, currently available web search technology is designed to assist users in finding information, but is not capable of assisting users in understanding the information or synthesizing the information into knowledge that can be used by others who may have similar information needs. It would be desirable to have a computerized process that allows for not only the finding of information but also the understanding of information across a broad spectrum of online databases.

Currently there are a number of solutions that allegedly provide a variety of methods and systems to facilitate searching a data collection, such as data disparately connected via a global telecommunications system such as the World Wide Web. Some of these methods and systems attempt to take advantage of the collective ability of users to create queries for the purpose of data collection. Generally speaking, these known methods and systems typically do not allow for or envision users collaborating in a structured arrangement of search queries that does not employ a hierarchical relationship between queries. In fact, most known methods and systems rely on categories, subcategories and subordinate relationships as well as the creation of taxonomies that are strictly enforced.

Still other methods and systems allow users to actively and transparently influence one another through joint search systems, but do not truly enable a working collaboration in a back-and-forth exchange. These methods and systems contemplate downstream users being influenced by other searches, bringing new search ideas and queries to bear, but not in an active, ongoing and truly collaborative refinement. Thus, these methods and systems describe searching techniques that allow individuals who are potentially unrelated and unknown to each other to search and others building upon previous searches in a static and potentially hierarchical manner.

These solutions fail to meet the needs of the industry because they do not enable search query refinement in a collaborative environment. Similarly, they fail to meet the needs of the industry because they do not enable the manual placement and arrangement of queries (in the form of text and tagged images) within a spatial environment so as to provide a particular visualization that impacts the deliverable relevance of what is returned to the users.

It would be desirable to have a computerized process that allows for not only the finding but also the understanding of information across a broad spectrum of online databases. In contrast to current processes, this would be best facilitated via the input and manual arrangement of related queries in the form of text and images within a spatial environment.

Furthermore, it would also be desirable for collaboration and targeted communication between users in relation to the input and arrangement of queries within a given spatial environment. This would make it possible for more efficient and targeted peer to peer assistance and guidance in online information finding, synthesis and ultimate understanding. Therefore, given the limitations of existing solutions, there currently exists a need in the information technology industry for a more collaborative and engaging computerized process for the effective finding and understanding of existing online information.

### SUMMARY OF THE INVENTION

In view of the foregoing, it is therefore an object of various embodiments of the invention to, among other things, provide a mechanism that allows individual users and groups of users to engage in collaborative searching for information through the manual placement and arrangement of queries in the form of media objects (e.g. text, tagged images, video and/or audio data) within a spatial environment. This manual placement and arrangement provides a particular visualization that impacts the deliverable relevance of what is returned to the users. Aspects of the invention incorporate manual, collaborative placement and arrangement of text and images within a spatial environment without reliance on hierarchical relationships. In certain embodiments it further includes drag and drop functionality within such a spatial environment.

The present invention advantageously allows users to be more expressive with their search queries beyond a simple keyword input within a search box, by allowing for the input of multiple queries of text and images within a spatial environment. This distinctly visually and contextually rich search environment facilitates collaboration and targeted communication between users.

The queries can be manually arranged by dragging and dropping within the spatial environment to create a rich visualization of contextual meaning. Further, the invention provides users with the ability to judge their own search performance and knowledge level against those of other users through the assigning of social status rankings. Moreover, the invention permits the user to access the knowledge of other individuals with an interest in the same or similar online search queries, through the use of a follow feature which in turn allows users to follow those who are more knowledgeable and search capable with a common interest. Still further, the invention provides access for multiple localized and third party databases to be selected from and filtered by user query input.

Exemplary embodiments of the present invention include a computer implemented method or process where the end user inputs queries in the form of text and/or images within a spatial environment. The queries in turn act as filters for localized and third party online databases, resulting in the display of search results. In the case where the query input is in the form of an image, a metadata tag in the form of a short text description accompanies the image, and it is the short description which is used to filter a database.

In one implementation the computer implemented process can be made up of the following executable steps: (1) A user inputs queries in the form of multi-media objects (which can be text, tagged images, video and or audio) within a spatial environment. (2) The queries in turn act as filters for localized and third party online databases, resulting in the display of search results. (3) In the case where a query input within a spatial environment is in the form of text, the text in its entity, or a manually highlighted selection of words within the text, acts as the filter for a database. (4) In the case where a query input within a spatial environment is in the form of an image, video or audio, a metadata tag in the form of a short description accompanies the query, and it is the short description which is used to filter a database.

In another implementation the user inputs text or an image within a spatial environment; the user manually positions the text or image within the spatial environment such as by drag and drop methodology; the user clicks on the text or image within the spatial environment in turn filters a localized or third party database resulting in the display of search results; and the input of additional text or images by a user results in a visual arrangement of multiples of topically related queries within the spatial environment. The result is a rich visualization of related queries.

In other various embodiments that build from the previous implementations one or more of the following optional executable steps may be present:

(1) Saving a spatial environment and its associated arrangement of text and images can occur so that it may be returned to at a later date. This saving can either automatically (i.e., upon some full-duplex communication condition or event, or as a result of a certain auto-save time lapse) or as the result of the user communicating with the interface manually (i.e., clicking on save). In some embodiments certain additions, amendments or movements of a media object by a user can automatically result in the new associated value logged automatically, thereby allowing users to return and further work within a spatial environment at a later date and time. In some embodiments all such additions, amendments or movements will result in the new associated value being logged and thereby saving for users to return at a later date and time.

(2) Allowing collaboration between end users in the input and manual arrangement of text and or images within a spatial environment. This is achieved by assigning a specific web address in the form of a URL to each spatial environment. Visiting the unique URL of a spatial environment may cause all of its logged inputs to date to be loaded and displayed to the user. All changes by users within a spatial environment may be are logged incrementally as they happen (i.e., upon some full-duplex communication condition or event, or as a result of a certain auto-save time lapse), thus multiple users from multiple remote locations may make changes within a single spatial environment simultaneously. In this way collaboration is possible on any given spatial environment. If multiple users remotely and simultaneously make changes to the same object within the spatial environment, all inputs may be logged, resulting in multiple objects being saved on the central server, and all users will be shown all variants within the spatial environment. To avoid or prohibit multiple concurrent users from simultaneously attempting to make changes to the same media object some or all users may (a) be visually informed of the current location of the cursor of one or more other users within a given spatial environment, (b) be visually informed of the identity of one or more users for each associated cursor and/or (c) visually identify a media object in real time as locked to concurrent users, other than the user actively inputting or modifying a multi-media object or associated search query while it is being moved or amended by a particular user.

(3) The selection of multiple localized and third party databases that will appear within a specific spatial environment. In certain aspects of the invention, third party databases may be filtered and have search results displayed, as a result of a query within the spatial environment being clicked on. An application programming interface (API) allows for the access of these databases. A list, accessible via a main menu, provides users with the names and description of all databases that are currently available. Selecting a database from the list will result in that particular database appearing on the screen. Multiple databases may be selected one at a time, and they will all appear on the screen. If multiple databases are selected, and a query is clicked on within the spatial environment, then all the present databases will be queried simultaneously and the user will be presented with search results from all of these databases.

(4) Provide access to the name of the originators of a media object, along with a text communication feature to allow for communication with that user in order to facilitate an understanding of the input. By way of example, when a user hovers over a media object (i.e. a section of text or an image) within the spatial environment, the identity of the user who originally input that object is displayed on the screen in the form of an associated avatar image and/or name in text. Selecting the displayed name or avatar in turn bring up a communication interface.

(5) Allowing end users to select who can participate in a session. When a session is first saved, it is then possible to be defined by an end user as either an Open Access Session, a Selective Access Session or a Personal Session. In an Open Access Session any registered and or unregistered user can access a session and add input. In a Selective Session any registered and/or unregistered user can request or can be invited to have input to the session. A request or invite can be initially granted by the end user who first has a session saved for them. Of those invited or who have had their input request granted, a select number can be therein authorized (authorized by the end user who first saved a session) to grant a request or instigate an invite. Access to a selective session is either open to all or restricted to those invited or that have a granted request. In a Personal Session any registered and or unregistered user who first saves a session may specify that only they may have input to a session, thereby granting subsequent users read-only access to the spatial environment. Access to such a personal session can either specified by the user who first saves a session (i.e., the primary user), as open to all users or restricted to the user who first saves a session. The session status (i.e., open with input/modification privileges, closed or open with read-only access) may be changed by the primary user at any time, or the spatial environment can be configured to prevent alterations in session status under some or all conditions. For example, the primary user may initially set the session to open with input/modification privileges and then later change the session to read-only. Additionally, the spatial environment can be configured to allow the aforementioned change only up to the point that a subsequent or secondary user accesses the spatial environment or up to the point that a subsequent or secondary user inputs/modifies a multi-media object and/or associated search query.

(6) Allow end users to “follow” other users. Users are kept informed of other particular users inputs within spatial environments. This is done by simply clicking on a user's name or avatar image that appears when hovering over any spatial environment input as described in step (4). When a user's name or avatar image is clicked, a list of their uploaded input (e.g. a text or image based media object) is displayed along with the corresponding spatial environment in which it was entered. Clicking on a particular input within the list causes the associated spatial environment to load, thus displaying the actual input in question. End users are able to restrict the level of detail which is made available to others who are following them about their activity within the application. This is achieved by selecting from a list of preferred privacy options. The options include, but are not limited to: “free access” where a record of all input may be accessed by others; “Limited access”, where only users who you manually specify have access to your input; and “No access”, where no input is made available to other users.

(7) Providing users with social status rankings, represented in text or image form. The social status rankings of a user may be calculated relative to all other users of a particular saved session. The social status rankings may also be calculated relative to all the users of the application. The social status rankings may be categorized and calculated based on a popularity of input added. The system may determine the popularity of input by tracking clicks on the associated query or media objects (in the form of text or tagged image) provided by a particular user. The user may be progressively given a higher social status ranking representing that number of clicks. The social status rankings may be also be categorized and calculated based on the volume or type of input provided by a particular user. Users are progressively given a higher social status ranking representing the total number of input they have made within the application as well as recording what that input was. The social status rankings may be also be categorized and calculated based on the number of followers a user has attracted. Users are progressively given a higher social status ranking representing the total number of other users who are keeping a tab on their sessions which they have saved, been invited to or have been granted a request to join.

(8) Providing a chat room feature to accompany each spatial environment, wherein the chat room may be a text based chat or a live video chat. This affords users the option to directly see and/or communicate with each other as they interact with media objects within a spatial environment.

(9) Providing the availability to “pan” and “zoom” as a means of navigating a particular spatial environment. The pan function allows for movement up, down, left and right at any degree or angle within a spatial environment. The zoom function allows for movement in or out within a spatial environment. Panning and zooming may be instigated via a range of input devices, such as via a mouse, stylus or touch sensitive screen.

(10) Inclusion of an “App Store” which gives users a selection of applications to be used within a given spatial environment. These optional applications may further enrich the collaboration afforded to users by broadening the range of activities on offer.

(11) Providing an Application Programming Interface (API) to facilitate the creation of applications, particularly to aid the creation of a wide spectrum of social and collaborative applications by third party developers, which may be used within the available spatial environments.

(12) Grouping of multiple existing spatial environments next to each other and create an effectively larger compilation spatial environment which may be tagged, saved and indexed for access by others.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRPTION OF THE DRAWINGS

FIG. 1A shows a block diagram illustrating a collaborative search system in accordance with an exemplary embodiment of the invention.

FIG. 1B shows a block diagram illustrating a collaborative search system in accordance with another exemplary embodiment of the invention.

FIG. 2A shows an interface diagram in accordance with an exemplary embodiment of the invention.

FIG. 2B shows an interface diagram in accordance with an exemplary embodiment of the invention.

FIG. 2C shows an interface diagram in accordance with an exemplary embodiment of the invention.

FIG. 2D shows an interface diagram in accordance with an exemplary embodiment of the invention.

FIG. 2E shows an interface diagram in accordance with an exemplary embodiment of the invention.

FIG. 2F shows a table of websites and their corresponding URL's with keywords present.

FIG. 3A shows an interface diagram in accordance with another exemplary embodiment of the invention.

FIG. 3B shows an interface diagram in accordance with another exemplary embodiment of the invention.

FIG. 3C shows an interface diagram in accordance with another exemplary embodiment of the invention.

FIG. 4A shows a flow diagram in accordance with an exemplary embodiment of the invention.

FIG. 4B shows a flow diagram in accordance with an exemplary embodiment of the invention.

FIG. 5 shows a flow diagram in accordance with another exemplary embodiment of the invention.

FIG. 6 shows a flow diagram in accordance with another exemplary embodiment of the invention.

FIG. 7A shows an alternative way, other than through the use of API's, that databases may be input and accessed.

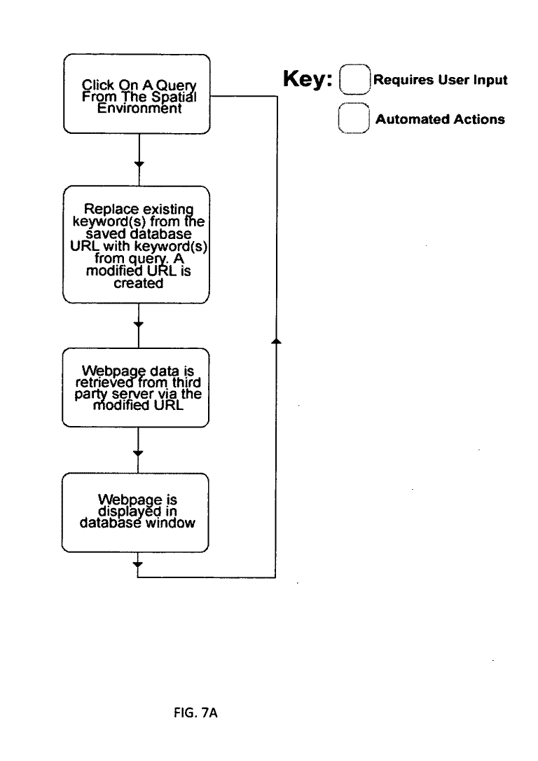

FIG. 7B shows still another alternative way, other than through the use of API's, that databases may be input and accessed.

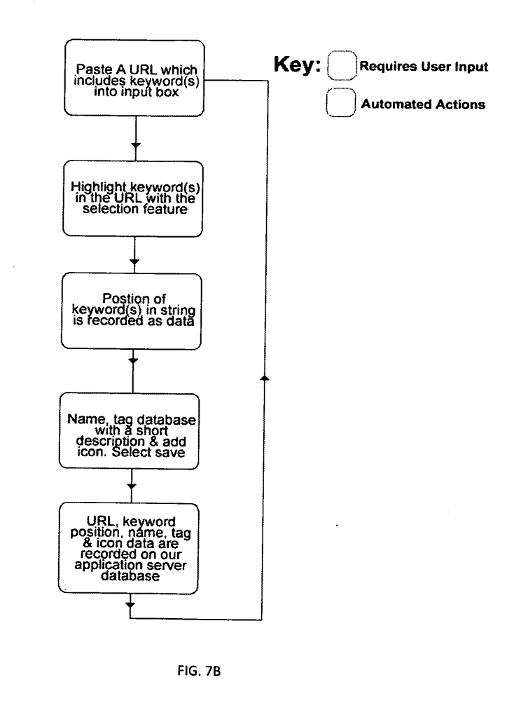

### DETAILED DESCRIPTION OF THE INVENTION

The present invention is directed to a system and method for providing a mosaic-like category and item navigation.

From time to time throughout this disclosure the terms “session” and “spatial environment” are used. Unless otherwise stated, session is intended to mean a continuous and specific period of time in which work is carried out by a user within a spatial environment. So session is the actions of a user over a continuous and specific period of time, whereas spatial environment is the location where the action is taking place.

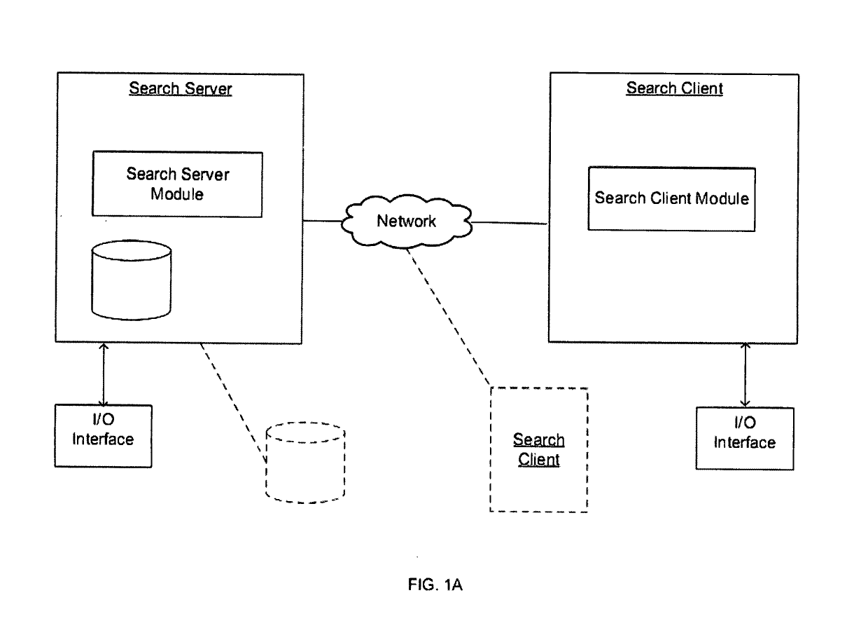

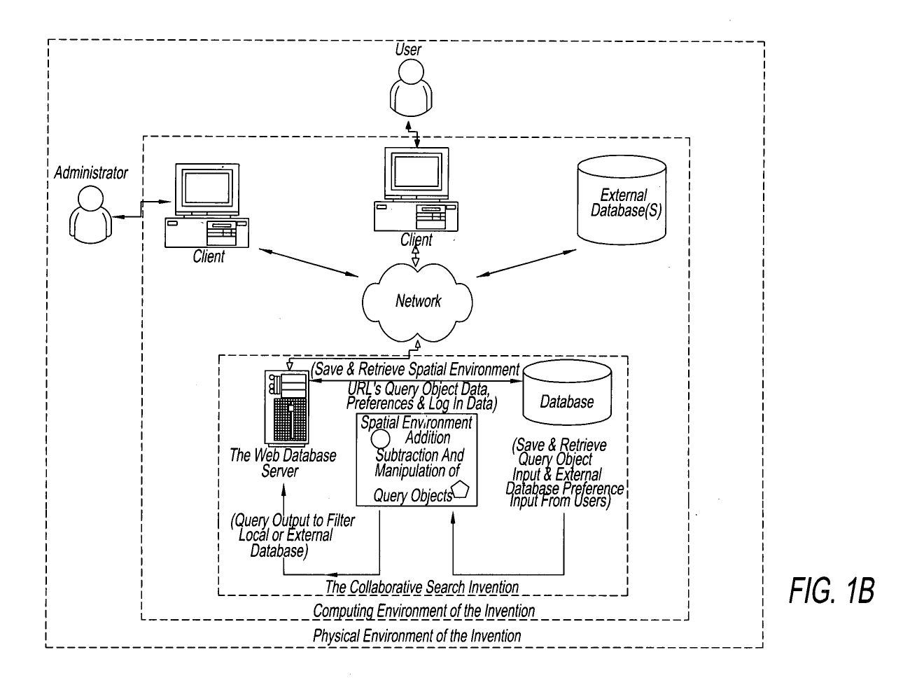

Referring to FIG. 1A, a block diagram is shown illustrating a collaborative search system in accordance with an exemplary embodiment of the invention. The collaborative search system comprises one or more client devices each of which includes a client search module, and a user Input/Output (I/O) interface. By way of example, the search client device may be a computing device having a processor and memory such as personal computer, a phone, a mobile phone, or a personal digital assistant. The client I/O interface may include a keyboard, mouse, monitor, touch screen or similar interface device suitable for allowing a user to interact with the client device. The client search module is responsible for handling communication with a search server and for providing a search interface to a user of the search client. The collaborative search system may also include a search server device communicatively coupled to each of the client devices by way of a network such as the Internet. The search server includes a server search module and a data repository for storing collaborative data (e.g. spatial environment data and user information). The data repository may also include one or more databases on which user queries may be performed. The search server may also be communicatively coupled to one or more remotely located computing devices containing third-party databases on which user's queries may also be performed. By way of example, the search server may be a single computing device having a processor and memory or may include multiple computers communicatively coupled in a distributed cloud-based architecture. The server search module is responsible for handling communication with each of the client devices, managing storage of user-defined search queries and for performing search queries (i.e. filtering) on local or remote content databases. The search server module may access the data repository in response to a search query request from one of the client devices.

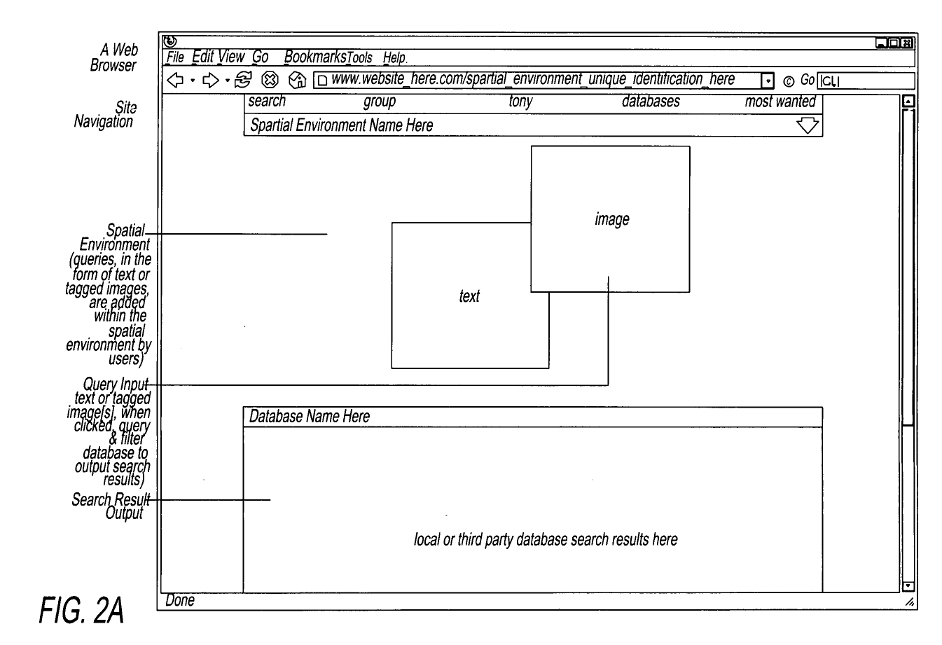

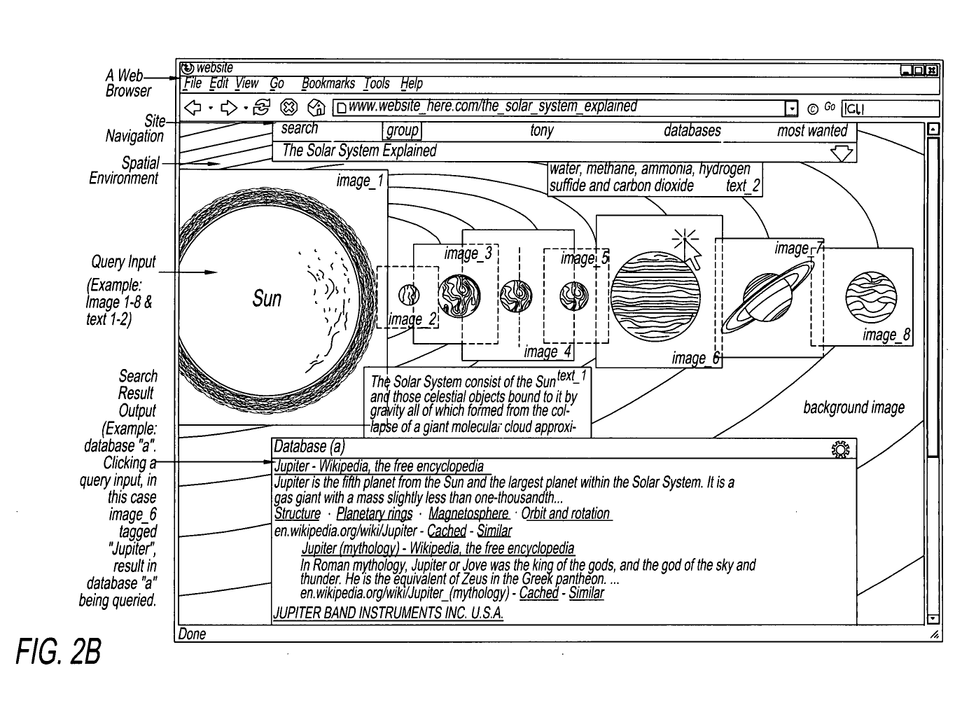

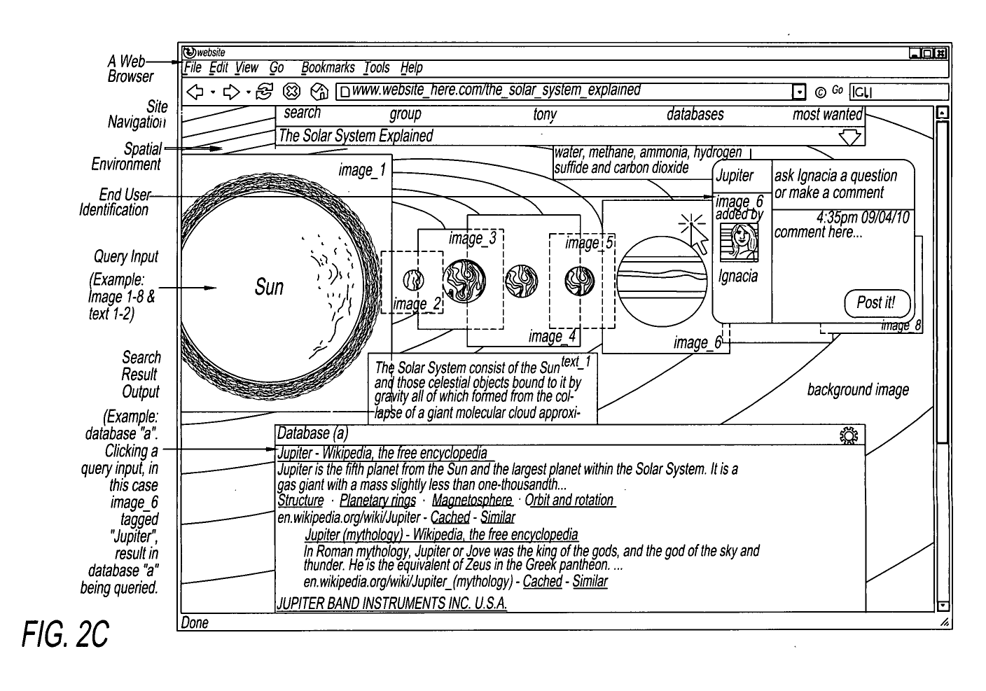

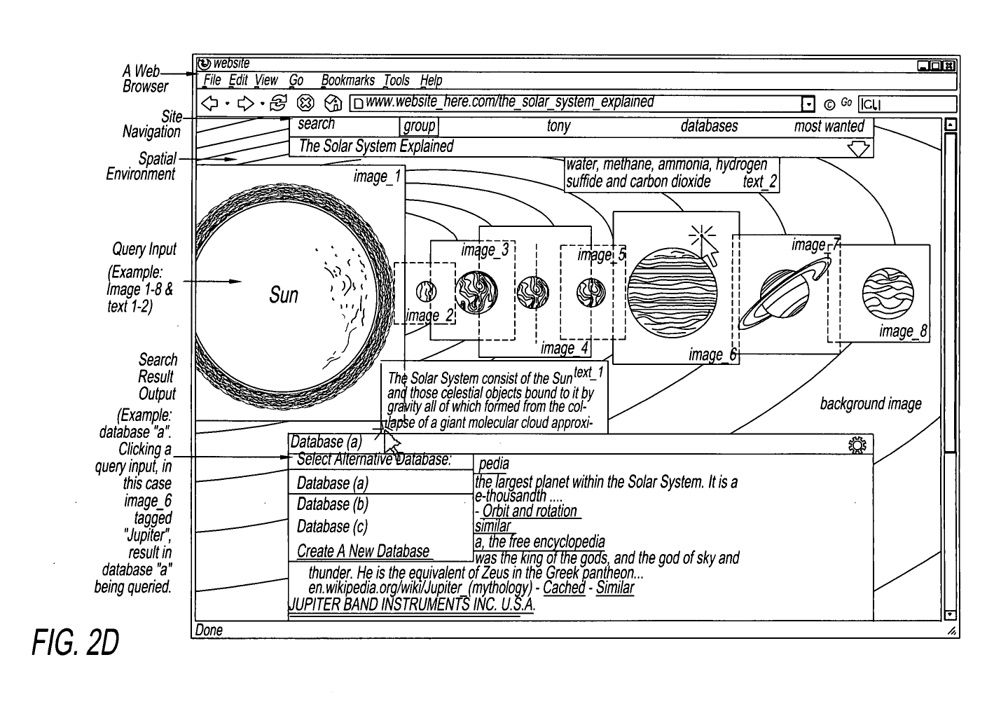

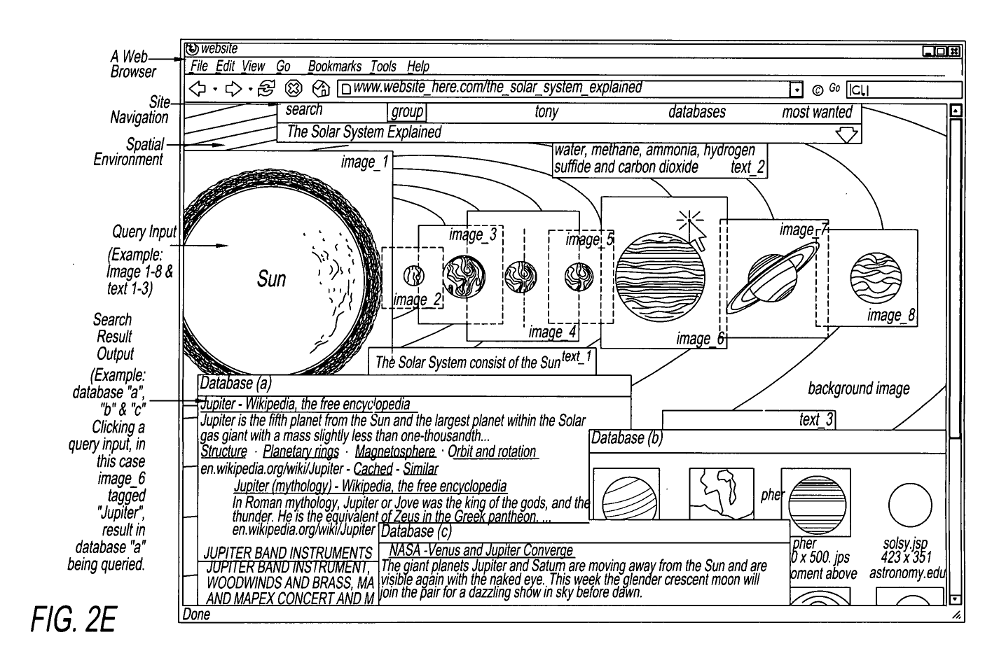

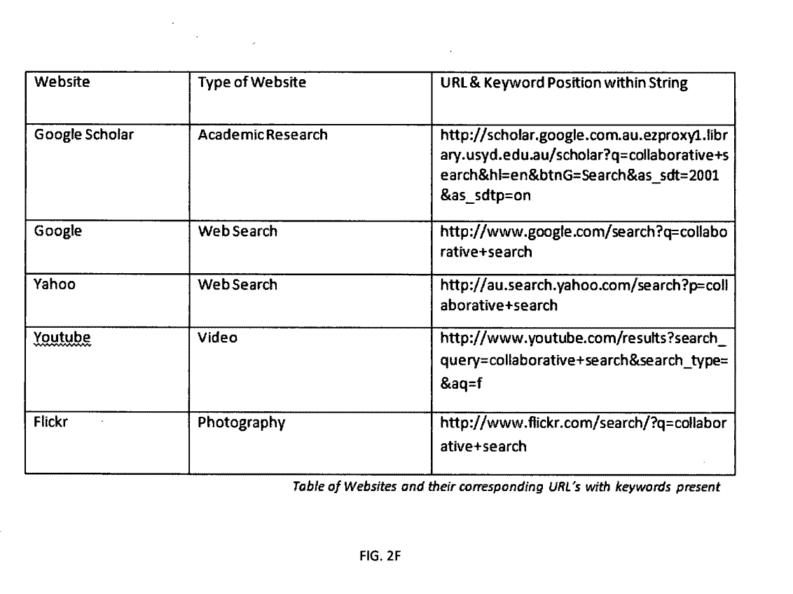

Referring now to FIG. 1B, a block diagram is shown illustrating a collaborative search system in accordance with an exemplary embodiment of the invention. As shown the collaborative search system may also support end users having different system permission levels. By way of an example, the system may support an administrator user for providing. As shown, the server device may be a web server or database server in communication with a data repository for storing spatial environment data and database preferences among other data. The client search interface will now be discussed in greater detail with reference to FIG. 2A through 2E.

Referring now to FIG. 2A through FIG. 2E, exemplary interface diagrams are shown for interacting with the collaborative search system shown in FIG. 1. As shown, the search interface may be a web-browser (e.g. Firefox or Google Chrome) based interface. It is noted however that the interface may be implemented as a standalone application suitable for being displayed on a desktop or mobile computing device. The search interface includes a site navigation bar for allowing a user to navigate to one or more unique spatial environments. By way of example, the user may enter a specific web address in the form of a URL, where the web address includes a predetermined unique identifier associated with a spatial environment of interest to the user. The search interface also includes a region for displaying such spatial environments. Each spatial environment contains one or more user-provided media objects (e.g. a section of text or a multi-media object such as an image) each of which is displayed in the spatial environment display region. Visiting the unique URL of a spatial environment will cause all previously logged multimedia objects to be loaded and displayed to the user in the spatial environment display region. The spatial environment display region may include pan and zooming capabilities so as not to constrain the quantity or size of media objects that can be added to the size of the screen on which the search interface is displayed. Each multi-media object is also associated with a search query. The search query may be a user-defined search query (e.g. one or more key words) entered at the time the media object is initially uploaded to the spatial environment, or it can be a search query added, or appended to an original search query, at a different time by a subsequent user. The search interface also supports selection (e.g. by clicking with a mouse device) of each of the multi-media objects. In response to a selection event, the search module will initiate a database query based on the search query associated with the selected multi-media object. The search interface may also provide controls for allowing a user to specify one or more databases upon which the search query is performed. The search interface further includes one or more search result output regions for displaying search query results retuned for each of the specified Is databases. The collaborative search interface may include a site navigation bar for allowing a user to select a desired program function.

As shown in FIG. 2B, the search interface also allows users of the system to position the user-provided multi-media objects relative to one another. By way of example, the search interface may allow such spatial positioning by providing a drag-and drop function. Users are thus provided with a means for positioning multi-media objects relative to one another in a manner that conveys contextual meaning. As shown, a spatial environment related to the solar system may include media objects (e.g. images of planets) that each correspond to a single planetary body. Users of the system may then position the media objects relative to one another to illustrate the relative distance that exists between each planetary body and the sun. As discussed the search interface supports media objects including text-based objects. When defining a text-based object a user may be provided with a control element for entering the section of text to be displayed within the spatial environment and further select (e.g. by highlighting with a mouse) sub-sections of the text that define the search query associated with the text-based multi-media object.

When multiple portions of text are selected (as shown in FIG. 2B) are each of the highlighted portions then clickable thereby creating multiple filters (e.g. {the, solar, system}, {sun}, and {gravity}. Any user can come along at any time and add or subtract the highlighting to determine specifically which portions can be queried. In the example provided a whole part of a sentence within the text has been highlighted “The Solar System”. In this case the databases on screen will be filtered for that phrase ‘The Solar System“. At the same time within the same text there are other highlighted portions, this time individual words for instance “sun” and “gravity”. All highlighted portions are independent of each other, regardless of whether they are all in the same body of text.

As shown in FIG. 2C, the search interface may also include a communication control element for allowing a user to communicate with other users who have contributed media objects to a spatial environment. Users may initiate communication with another user by selecting on a media object. By way of example, when a user hovers over a media object the identity of the user who originally input that object is displayed on the screen in the form of an associated avatar image and/or name in text. Upon selecting the displayed name or avatar a dialogue box is displayed to the user that allows a message (e.g. a question) to be sent to the user who contributed the media object to the spatial environment. The search interface allows the user to post the message which as shown may be displayed within the spatial environment. The original contributor of the media object may then be notified of the posted question (e.g. by e-mail or via a user account screen) and respond by the same communication control element. In this manner the search system allows users to collaborate on individual media elements within a spatial environment.

The database name in the main window of the application (as illustrated in FIG. 2D), can be clicked on by end users to either select an alternative or to allow them to add their own databases into the application by clicking “Create a new database” as illustrated in FIG. 2D. End users are presented with an input box where they can paste a URL address, provided that the URL pasted contains at least one keyword. Acceptable examples of URL's are shown in FIG. 2F.

Upon posting a URL containing at least one keyword, users are instructed via the highlight feature to select the keyword(s) in the URL string. Next, a user is asked to provide a name, a tag description and an identifying icon. The application then proceeds to save on its database server the URL, position of keyword(s) in the URL, the name, tag and icon input from the user.

Users are able to select a database such as the one added as described above from a list in the main menu. Upon selecting such a database its name will appear in the location “Database Name Here” as illustrated in FIG. 2A. Clicking on any media object present in the spatial environment will automatically result in the media objects keyword(s) being inserted in the place of the highlighted portion of the URL, resulting in a modified Url. The modified URL allows our application to now access the specific web page of search results that corresponds to the keyword(s) of the media object that was selected. The search results are displayed in the database window. In this way media objects may be clicked on and relevant search results will always be displayed in the database window.

As discussed, users may select multiple databases located local or remotely from the search server. As shown in FIG. 2E the search interface supports simultaneous display of the search query results for each of the databases upon which the query is applied. By way of example, a predetermined database list, accessible via a main menu, provides users with the names and description of all databases that are currently available. Selecting a database from the list will result in that particular database appearing on the screen. Multiple databases may be selected one at a time, and they will all appear on the screen. If multiple databases are selected, and a query is clicked on within the spatial environment, then all the present databases will be queried simultaneously and the user will be presented with search results from all of these databases.

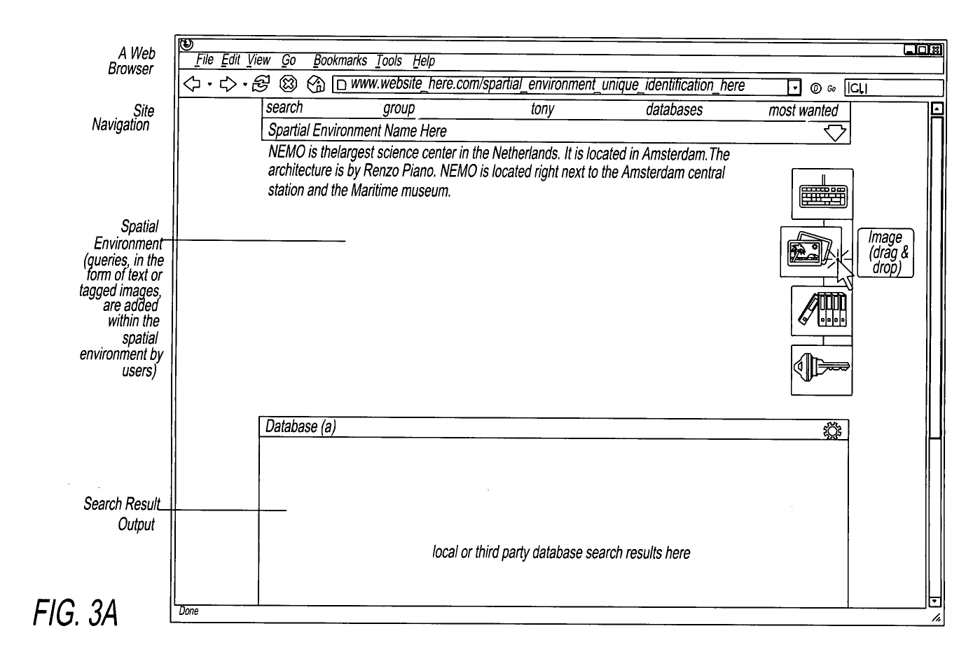

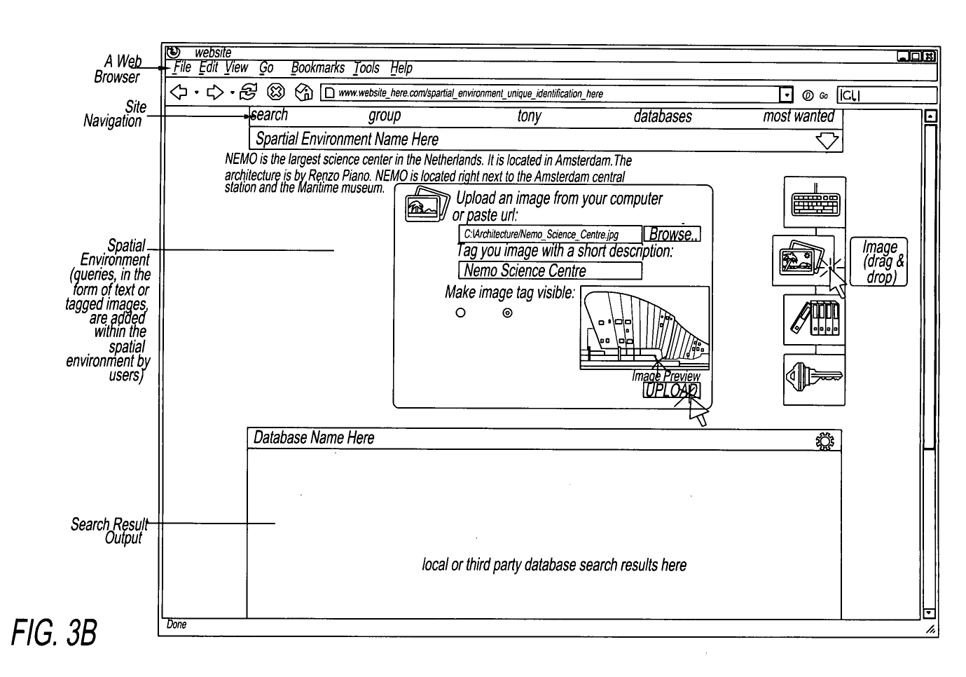

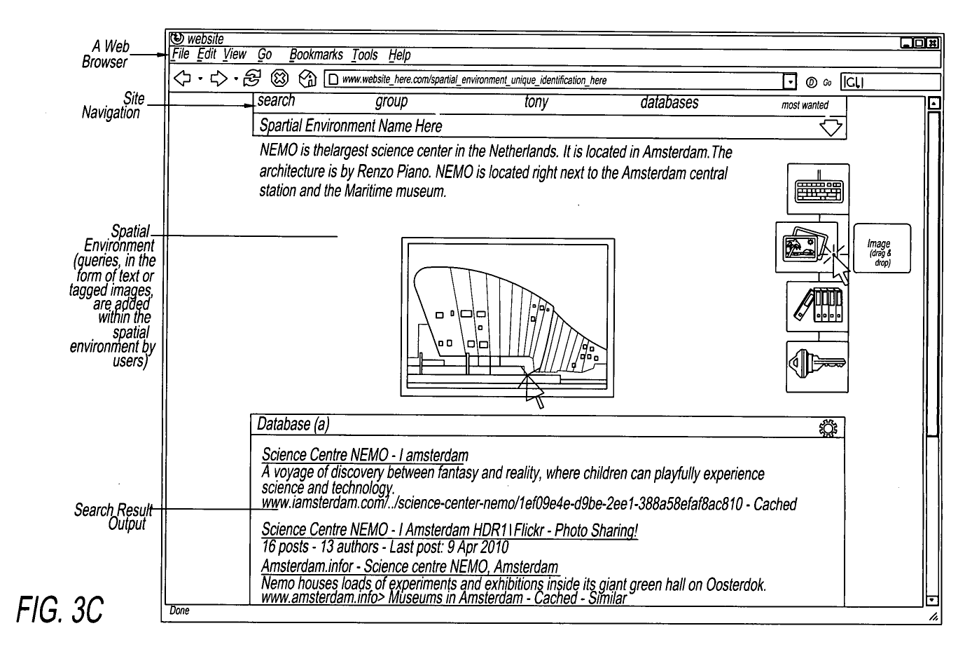

Referring now to FIG. 3A through FIG. 3C, interface diagrams are shown illustrating another exemplary interface for interacting with the collaborative search system shown in FIG. 1. In particular, FIG. 3A through 3C illustrate exemplary control elements that may be provided by the search interface for adding new media objects (e.g. text or images) to a spatial environment. As shown in FIG. 3A the search interface may include menu options for adding a text-base media item (shown as a keyboard icon) and an image-based media item (icon shown as being selected via a mouse pointer). FIG. 3B illustrates a media upload window that is provided by the search interface for allowing a user to select (e.g. from a local or remote file system) or provide a hyperlink to a particular media object. The media upload window also includes a text field for receiving a tag (i.e. a short text description) of the media object from the user. The search query associated with the media object is derived from the entered tag. Upon uploading the media object a visual representation of the media object will be placed within the spatial environment (as shown in FIG. 3C) and made available to users who have been given permission to view the spatial environment. After the media object is placed in the spatial environment, the search interface allows the user to move the visual representation of the media object to a desired location on the screen (e.g. via drag-and-drop). As discussed, the search interface also supports selection (e.g. by clicking with a mouse device) of each of the multi-media objects. In response to a selection event, the search module will initiate a database query based on the search query associated with the selected multi-media object.

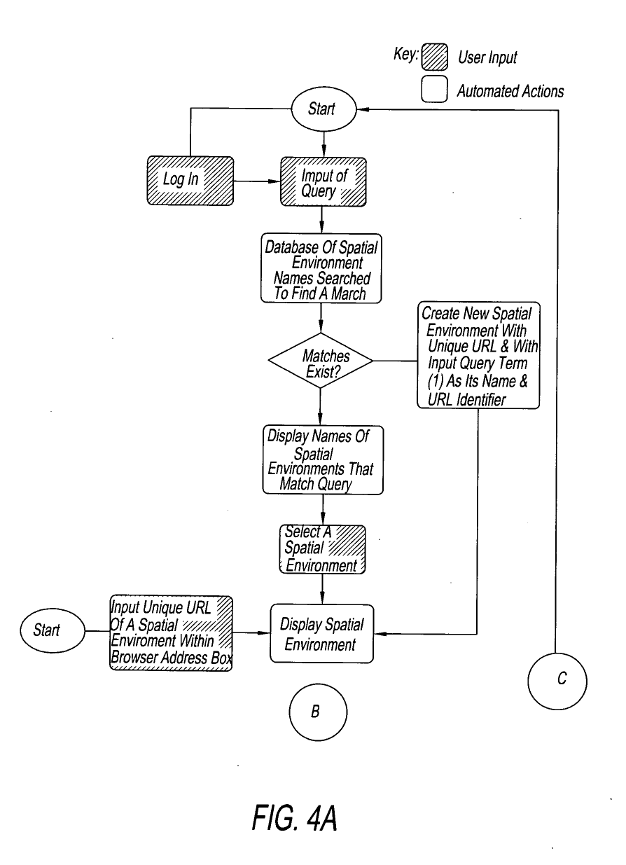

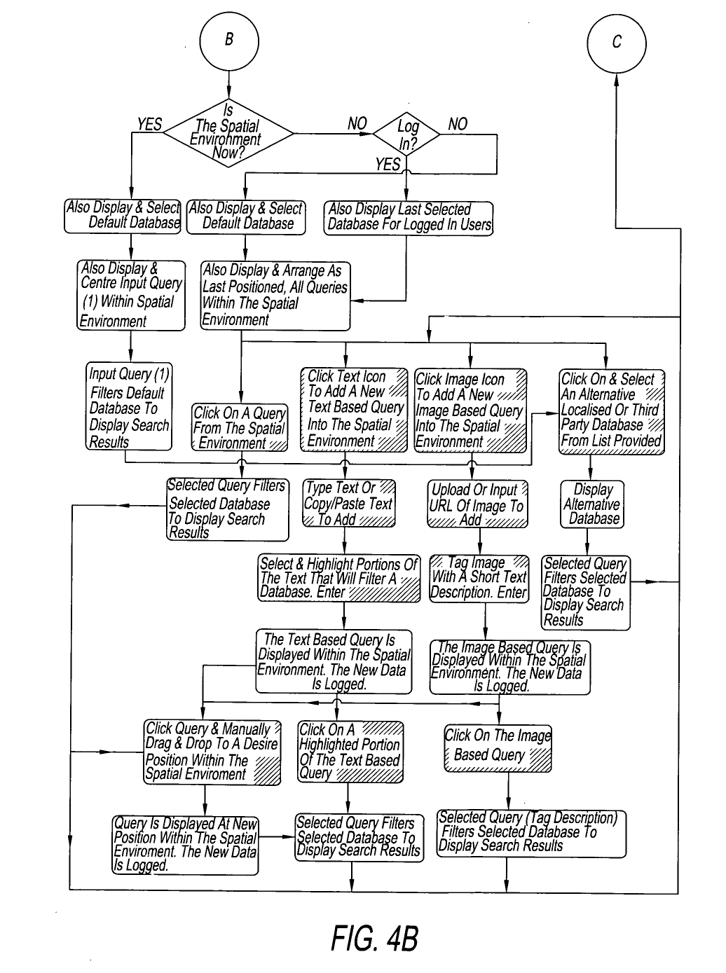

Referring now to FIG. 4A and FIG. 4B, a flow diagram is shown that illustrates a computer-implemented process or method that may be carried out with the exemplary collaborative search system. FIG. 4A illustrates a first series of steps that occur between the search server device and one of the search client devices. As shown, a user of the system may first perform a search of the existing spatial environments to determine if a spatial environment already exists that relates to a search query of interest. The client search module communicates the desired search query to the search server. In response the server search module will perform a search of the spatial environments stored in the server data repository (e.g. by searching the associated web addresses) to determine if a related search query already exists. The server search module returns any matching results to the client search device. The user may then opt to create a new spatial environment or select an existing spatial environment. The server search module responds to a request for an existing spatial environment by providing the client device with all of the logged multimedia objects associated with the spatial environment which the client search module in turn displays to the user via the search interface. As shown the user may alternatively opt to initiate the process by creating a new spatial environment. The client search module simply requests the server search module to create a new spatial environment record in the server data repository.

FIG. 4B illustrates further steps that may occur between the search server device and the search client devices. As shown, the user may perform one of several operations on the spatial environment including: performing a query, adding one or more new media objects, and modifying the properties of an existing media object (e.g. query text, spatial positioning). With each operation the client search module receives the requested operation from the user via the search interface and passes the request to the search server module. The search server module in turn accesses the server data repository to create, read, update or delete properties of a new or existing spatial record in order to accurately log changes made at the client device. In this manner the state of a particular spatial environment is maintained even when different users interact with the spatial environment at different client devices. The process of FIG. 4B also allows a user to select one or more databases upon which queries will be performed. As shown the database may be a local or third party remote database and may be selected as a default database for all queries performed within a spatial environment. One or more databases may alternately be associated with a particular media object.

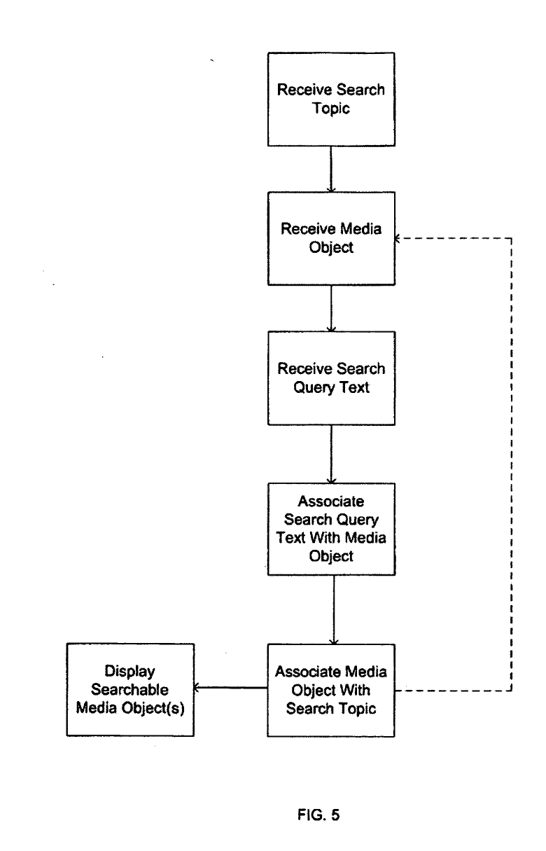

Referring now to FIG. 5, a flow diagram is shown that illustrates another computer-implemented process or method that may be carried out with the exemplary collaborative search system. As shown, a search topic selection may be received by a client device (e.g. by selecting a spatial environment). The client device may then receive a media object (e.g. a section of text or an image) and an associated search query. The media object is then associated with the search topic and displayed as a searchable object within the search topic. The media object is searchable in that a user-selection of the object (e.g. by clicking) will automatically initialize a database search based on the search query previously associated with the object. It is noted that users of the system may update the search query text for existing media objects in a similar manner.

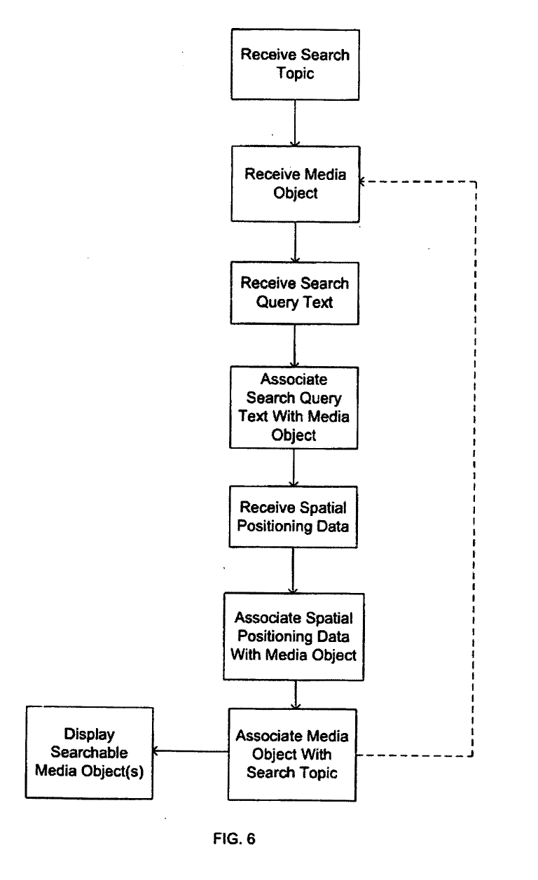

Referring now to FIG. 6, a flow diagram is shown that illustrates another computer-implemented process or method that may be carried out with the exemplary collaborative search system. The process of FIG. 6 proceeds in a similar manner to that shown in FIG. 5 and further includes the steps of receiving spatial positioning data (e.g. in response to a user moving an object by drag-and drop) that is also associated with the media object. In this manner, each media object associated with a search topic may be displayed at a specific position (relative to other media objects associated with the same search topic) in a consistent manner. It is noted that users of the system may update the spatial positioning for existing media objects in a similar manner.

The various illustrative program modules and steps described in connection with the embodiments disclosed herein may be implemented as electronic hardware, computer software, or combinations of both. The various illustrative program modules and steps have been described generally in terms of their functionality. Whether the functionality is implemented as hardware or software depends in part upon the hardware constraints imposed on the system. Hardware and software may be interchangeable depending on such constraints. As examples, the various illustrative program modules and steps described in connection with the embodiments disclosed herein may be implemented or performed with an application specific integrated circuit (ASIC), a field programmable gate array (FPGA) or other programmable logic device, discrete gate or transistor logic, discrete hardware components, a conventional programmable software module and a processor, or any combination thereof designed to perform the functions described herein. The processor may be a microprocessor, CPU, controller, microcontroller, programmable logic device, array of logic elements, or state machine. The software module may reside in RAM memory, flash memory, ROM memory, EPROM memory, EEPROM memory, hard disk, a removable disk, a CD, DVD or any other form of storage medium known in the art. An exemplary processor may be coupled to the storage medium so as to read information from, and write information to, the storage medium. In the alternative, the storage medium may be integral to the processor.

In further embodiments, those skilled in the art will appreciate that the foregoing methods can be implemented by the execution of a program embodied on a computer readable medium. The medium may comprise, for example, RAM accessible by, or residing within the device. Whether contained in RAM, a diskette, or other secondary storage media, the program modules may be stored on a variety of machine-readable data storage media, such as a conventional “hard drive”, magnetic tape, electronic read-only memory (e.g., ROM or EEPROM), flash memory, an optical storage device (e.g., CD, DVD, digital optical tape), or other suitable data storage media.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A computer implemented method for using a system to find and refine information comprising:
a user manually placing and arranging at least one primary multi-media object within the spatial environment wherein each primary multi-media object is associated with a search query;
the search module initiating one or more database queries based on the search query associated with the at least one primary multi-media object;
displaying search query results returned for each of the one or more database queries in one or more search result output regions;
saving the spatial environment and its associated arrangement of the at least one primary multi-media object, the associated search query and the search query results.

2. The computer implemented method of claim 1 further comprising a plurality of secondary users manually placing and arranging at least one secondary multi-media object within the spatial environment wherein each at least one secondary multi-media object is associated with a corresponding search query.

3. The computer implemented method of claim 2 wherein the user and the plurality of secondary users are concurrently using the system.

4. The computer implemented method of claim 3, wherein at least one of (a) the primary multi-media object, (b) the search query associated with the primary multi-media object, (c) the secondary multi-media object and (d) the search query associated with the secondary multi-media object, are an active item currently accepting input or modification.

5. The computer implemented method of claim 3 further comprising:
assigning a unique URL to the spatial environment.

6. The computer implemented method of claim 4 further comprising:
automatically logging changes within the spatial environment in real time.

7. The computer implemented method of claim 6 further comprising prohibiting the simultaneous modification of the at least one active item by concurrent users.

8. The computer implemented method of claim 7 wherein the prohibiting step entails locking the at least one active item to prevent simultaneous modification by more than one concurrent user.

9. The computer implemented method of claim 7 further comprising appending a new search query to a previously entered multi-media object into the spatial environment.

10. The computer implemented method of claim 9 wherein the newly appended search query is entered by an individual other than the user who originally entered the multi-media object into the spatial environment.

11. The computer implemented method of claim 7 wherein access to the spatial environment can only be gained by invitation of the primary user to the plurality of secondary users.

12. The computer implemented method of claim 1 further comprising the primary user setting a session status for the spatial environment to define the level of interaction allowed by a plurality of secondary users.

13. The computer implemented method of claim 12 wherein the session status set for the plurality of secondary users allows them to gain read-only access to the spatial environment.

14. The computer implemented method of claim 12 wherein the session status for the spatial environment can be altered after being initially set by the primary user.

15. The computer implemented method of claim 7 further comprising a compilation creator grouping of multiple constituent spatial environments in proximity to one another on a display screen thereby creating a compilation spatial environment.

16. The computer implemented method of claim 15 wherein the compilation spatial environment is saved, tagged and indexed.

17. The computer implemented method of claim 16 further comprising the compilation creator setting a session status for the spatial environment to define the level of interaction allowed by a plurality of secondary users.

18. The computer implemented method of claim 7 further comprising selecting a search topic for association with the multi-media object and displaying as a searchable object within the search topic.

19. The computer implemented method of claim 18 further comprising receiving spatial positioning data associated with the multi-media object.

20. The computer implemented method of claim 19 further comprising associating the spatial positioning data with the search topic.
